(19) United States
(12) Patent Application Publication
(10) Pub. No.: US 2013/0219086 A1
(43) Pub. Date: Aug. 22, 2013

(54) ELECTRONIC DEVICE CAPABLE OF AUTOMATICALLY SWITCHING MODES OF A MEMORY MODULE AND RELATED METHOD

(71) Applicants: Po-Chun Hu, New Taipei City (TW); Tsung-Shang Huang, New Taipei City (TW)

(72) Inventors: Po-Chun Hu, New Taipei City (TW); Tsung-Shang Huang, New Taipei City (TW)

(21) Appl. No.: 13/568,147

(22) Filed: Aug. 7, 2012

(30) Foreign Application Priority Data
Feb. 22, 2012 (TW) 101105798

(51) Int. Cl. G06F 3/00

(52) U.S. Cl. 710/14

(57) ABSTRACT

A method of automatically switching modes of a memory module is disclosed in the present invention. The method includes enabling an auto-switch program, reading an actuating value in database, triggering a sensor, comparing the actuating value and an environmental parameter sensed by the sensor, and switching the mode of the memory module when the environmental parameter corresponds to the actuating value.

### BACKGROUND OF THE INVENTION

1. Field of the Invention

The present invention relates to an electronic device having a memory module, and more particularly, to an electronic device capable of automatically switching modes of the memory module and a related method.

2. Description of the Prior Art

Generally, a conventional portable electronic device is coupled to a host via a cable with USB interface. The conventional portable electronic device can be a smart phone, and a user can use the host to read information from a memory module of the smart phone. A conventional connection of the smart phone is connecting two ends of the cable respectively to the portable electronic device and the host, and manually switching an operating mode of the portable electronic device via the display interface in Android, so as to start storage function of the portable electronic device. The conventional connection is complicated. The user actuates the display interface, selects the operating mode from a list shown in the display interface, and then the operating mode of the portable electronic device can be switched according to user's demand. The conventional connection has drawbacks of long setting period and inconvenient operation. Therefore, design of a portable electronic device and a related method that can switch the operating modes simply and automatically is an important issue to enhance operation convenience of the portable electronic device.

### SUMMARY OF THE INVENTION

The present invention provides an electronic device capable of automatically switching modes of the memory module and a related method for solving above drawbacks.

According to the claimed invention, a method of automatically switching modes of a memory module of an electronic device is disclosed. The method includes enabling an auto-switch program, reading an actuating value in database, triggering a sensor, comparing the actuating value and an environmental parameter sensed by the sensor, and switching the mode of the memory module when the environmental parameter corresponds to the actuating value.

According to the claimed invention, the method further includes reading a plurality of actuating values in the database, triggering a plurality of sensors, comparing the plurality of actuating values and the environmental parameters sensed by the corresponding sensors, and switching the mode of the memory module when the environmental parameters correspond to the actuating values.

According to the claimed invention, reading the actuating value in the database includes starting a setting program when the database does not store the actuating value, listing a plurality of sensors, selecting at least one sensor, triggering the selected sensor to generate a sensing value, and storing the sensing value into the database to be the actuating value.

According to the claimed invention, reading the actuating value in the database further includes setting a tolerance of the sensing value, and storing the sensing value and the tolerance into the database to be the actuating value.

According to the claimed invention, the tolerance is substantially equal to ten percent of the sensing value.

According to the claimed invention, comparing the actuating value and the environmental parameter sensed by the sensor includes disabling the auto-switch program when the environmental parameter does not correspond to the actuating value.

According to the claimed invention, switching the mode of the memory module of the electronic device includes coupling the memory module of the electronic device to be an external memory module of an external host when the electronic device is electrically connected to the external host.

According to the claimed invention, the sensor is an illumination sensor, a distance sensor, a linear acceleration sensor, a gyroscope sensor or a magnetic sensor.

According to the claimed invention, an electronic device capable of auto-switching memory module modes is disclosed. The electronic device includes a memory module, a connector, at least one sensor, a database and a controller. The connector disposed on the memory module, and the memory module is electrically connected to an external host via the connector. The sensor is triggered to sense an environmental parameter. The database is for storing an actuating value. The controller is electrically connected to the memory module, sensor and the database. The controller is for reading the actuating value from the database after an auto-switch program is enabled, comparing the actuating value and the environmental parameter, and switching a mode of the memory module when the environmental parameter corresponds to the actuating value.

According to the claimed invention, the electronic device further includes a display interface electrically connected to the controller. The controller drives the display interface to list a plurality of sensors when the controller does not read the actuating value from the database, and triggers at least one selected sensor to generate a sensing value, so as to store the sensing value into the database to be the actuating value.

The present invention utilizes the sensors to sense the environmental parameters of the position whereon the electronic device is located, and compares the environmental parameters to the actuating values stored inside the built-in database, so as to determine whether the modes of the memory module can be switched. Because the electronic device (the common smart phone) includes many kinds of sensors, such as the illumination sensor, the distance sensor, the linear acceleration sensor, the gyroscope sensor or the magnetic sensor, the controller can read the environmental parameters sensed by the different kinds of sensors, and then utilize the comparison of the environmental parameters and the predetermined actuating values to be the reference for switching the modes of the memory module. Comparing to the prior art, the present invention has preferred convenience instead of the conventional manual inputting operation. The electronic device of the present invention can utilize the controller to execute the comparison and to switch the mode of the memory module automatically when the electronic device is put under the predetermined condition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an electronic device according to an embodiment of the present invention.

FIG. 2 is a flow chart of a setting of auto-switching the modes of a memory module according to the embodiment of the present invention.

FIG. 3 is a diagram of a display interface according to the embodiment of the present invention.

FIG. 4 is a flow chart of an operation of auto-switching the modes of the memory module according to the embodiment of the present invention.

FIG. 5 is a diagram illustrating the electronic device with software according to the embodiment of the present invention.

### DETAILED DESCRIPTION

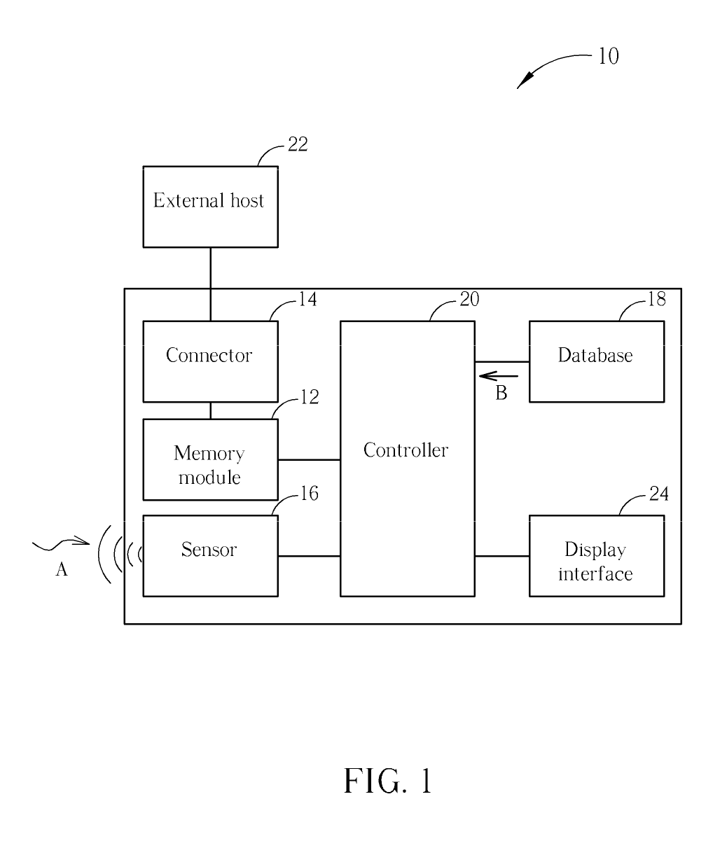

Please refer to FIG. 1. FIG. 1 is a functional block diagram of an electronic device 10 according to an embodiment of the present invention. The electronic device 10 can be an Android smart phone, especially installing Android 2.3. The electronic device 10 of the present invention can utilize the sensors to sense environmental parameters of the position whereon the smart phone is located, and can switch modes of the memory module when the environmental parameter corresponds to a predetermined condition. The predetermined condition can be set by a user. Therefore, the present invention can increase operation efficiency and avoid inconvenience of the conventional manual inputting operation.

As shown in FIG. 1, the electronic device 10 includes a memory module 12, a connector 14, at least one sensor 16, a database 18 and a controller 20. Generally, the memory module 12 of the smart phone can be a removable memory disk, such as Micro SD or Mini SD. The connector 14 can be an USB interface, which is disposed on the memory module 12. The electronic device 10 can be electrically connected to an external host 22 via the connector 14, so as to share information of the memory module 12 with the external host 22. The sensor 16 can sense the environmental parameter A. For example, the sensor 16 can be an illumination sensor, a distance sensor, a linear acceleration sensor, a gyroscope sensor or a magnetic sensor. The environmental parameter A can be illumination variation of the electronic device 10, distance variation that whether the user moves close to the electronic device 10, linear acceleration variation, angular acceleration variation, and magnetic direction variation of the electronic device 10.

In addition, the database 18 can store an actuating value B, and the controller 20 can connect to the database 18 for reading and analyzing the actuating value B. The database 18 can be disposed inside the memory module 12 or be disposed on an internal memory of the electronic device 10, alternatively. Disposition of the database 18 depends on design demand, and a detailed description is omitted herein for simplicity. The controller 20 is electrically connected to the memory module 12 and the sensor 16. The controller 20 can read the actuating value B from the database 18 when an auto-switch program is enabled, and compare the actuating value B to the environmental parameter A sensed by the sensor 16 for determining whether the modes of the memory module 12 is switched. Furthermore, the electronic device 10 can further include a display interface 24 electrically connected to the controller 20. The display interface 24 can be a touch panel, and the user can utilize the display interface 24 to set the actuating value B into the database 18.

It should be mentioned that the electronic device 10 can include a plurality of sensors 16 for respectively sensing a plurality of environmental parameters A. For preventing the electronic device 10 from switching the modes of the memory module 12 as receiving one environmental parameter A, the present invention can preferably set that the controller 20 switches the modes of the memory module 12 after the plurality of environmental parameters A respectively corresponds to the plurality of corresponding actuating values B. Therefore, identify complication of the auto-switch program can be increased effectively, and the memory module 12 of the electronic device 10 can be coupled to the external host 22 when a plurality of comparison is matched.

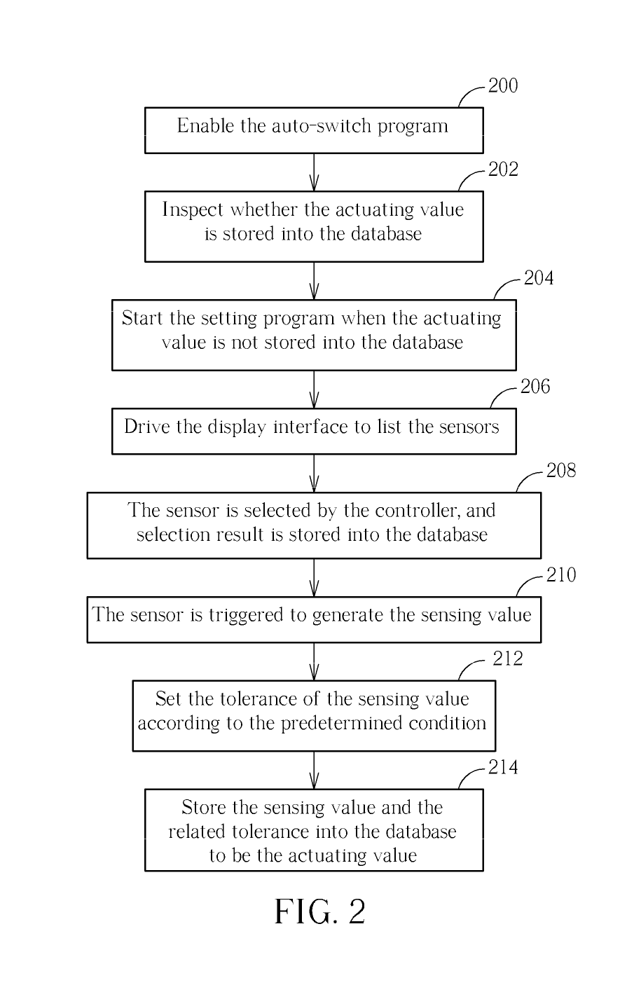

Please refer to FIG. 2. FIG. 2 is a flow chart of a setting of auto-switching the modes of the memory module 12 according to the embodiment of the present invention. The setting method includes following steps:

Step 200: Enable the auto-switch program.

Step 202: The controller 20 inspects whether the actuating value B is stored into the database 18.

Step 204: Start the setting program when the actuating value B is not stored into the database 18.

Step 206: The controller 20 drives the display interface 24 to list the plurality of sensors 16. The user can choose one or more of the sensors 16 to be the applied sensors.

Step 208: At least one sensor 16 is selected by the controller 20 according to user's demand, and selection result is stored into the database 18. Generally, the user preferably chooses at least two sensors 16 for use.

Step 210: The controller 20 triggers the selected sensor 16 to generate the sensing value. An amount of the sensing values corresponds to an amount of the selected sensors 16.

Step 212: Set a tolerance of the sensing value according to the predetermined condition.

Step 214: The controller 20 stores the sensing value and the related tolerance into the database 18 to be the actuating value B.

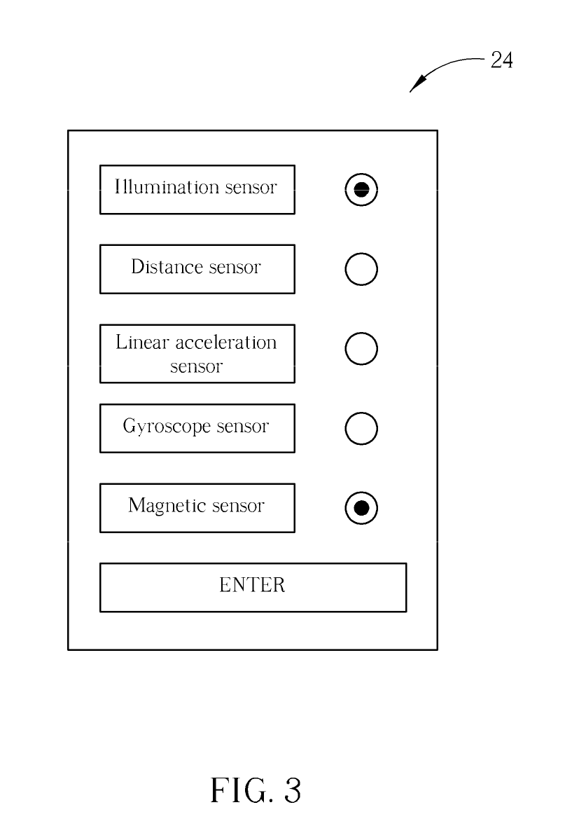

Detailed description of the above-mentioned steps is introduced. The auto-switch program of the electronic device 10 is enabled manually, so that initialization of the electronic device 10 is executed by the controller 20, and then the controller 20 inspects that whether the actuating value B has been stored into the database 18. The controller 20 enables the setting program when the database 18 does not include the actuating value B. First, the controller 20 can drive the display interface 24 to list option of the plurality of sensors 16. The user can choose one of the sensors 16 or more according to actual demand. Please refer to FIG. 3. FIG. 3 is a diagram of the display interface 24 according to the embodiment of the present invention. The plurality of sensors 16 of the electronic device 10 can be listed on the display interface 24 through a liquid crystal display. The sensor 16 can be the illumination sensor, the distance sensor, the linear acceleration sensor, the gyroscope sensor or the magnetic sensor. The user can choose at least one sensor 16 to be reference of the auto-switch program, and the selection result is stored into the database 18.

In the embodiment of the present invention, the electronic device 10 can preferably set the plurality of sensors 16 to be the reference of the auto-switch program. For example, the user can choose the illumination sensor and the magnetic sensor to be the applied sensors 16 via the display interface 24. The controller 20 can store the selection result (a category of the selected sensor) into the database 18, and trigger the illumination sensor and the magnetic sensor to respectively generate the corresponding sensing values, so as to sense the environmental parameters of the position whereon the electronic device 10 is located. The above-mentioned environmental parameters can be values of the illumination and directions of the magnetic field. As the electronic device 10 is put under a desk lamp and points toward the east, the controller 20 can set the sensed illumination and the sensed magnetic field (the sensing values) to be the actuating values B, and store the sensing values into the database 18 for the auto-switch program. Later, the electronic device 10 can automatically switch the modes of the memory module 12 when the user put the electronic device 10 under the desk lamp with the same illumination and toward the east.

For increasing comparison accuracy of the environmental parameter A and the actuating value B by the controller 20, the present invention can set the tolerance according to the predetermined condition, and the tolerance can be preferably equal to ten percent of the sensing value. For example, the sensing value (the illumination) of the sensor 16 (the illumination sensor) is 300 candlepower, and the corresponding actuating value B can be within a range between 270 candlepower and 330 candlepower. The sensing value (the magnetic field) of the sensor 16 (the magnetic sensor) is toward the east, and the corresponding actuating value B can be around a range that has ten percent inclination of the east.

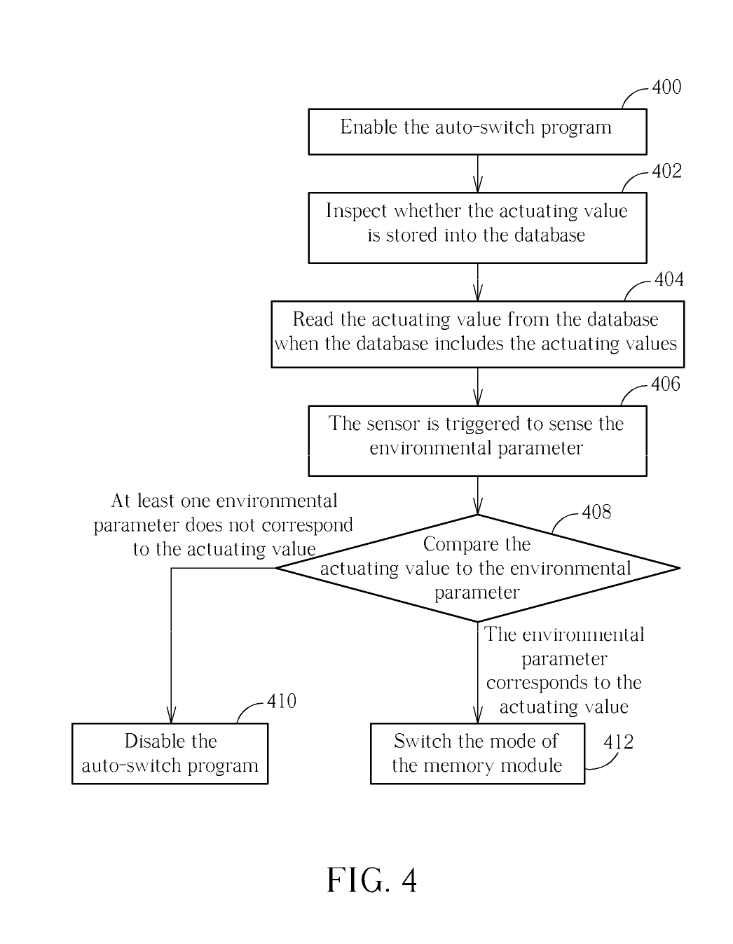

Please refer to FIG. 4. FIG. 4 is a flow chart of an operation of auto-switching the modes of the memory module 12 according to the embodiment of the present invention. The method includes follow steps:

Step 400: Enable the auto-switch program.

Step 402: The controller 20 inspects whether the actuating value B is stored into the database 18.

Step 404: The controller 20 reads the actuating value B from the database 18 when the database 18 includes the actuating values B.

Step 406: Function of the sensor 16 is triggered to sense the environmental parameter A.

Step 408: The controller 20 compares the actuating value B to the environmental parameter A. An amount of the actuating value B corresponds to an amount of the environmental parameter A. Execute step 410 when at least one environmental parameter A does not correspond to the actuating value B; Execute step 412 when the environmental parameter A corresponds to the actuating value B.

Step 410: The auto-switch program is disabled by the controller 20.

Step 412: The mode of the memory module 12 is switched by the controller 20.

Detailed description of the above-mentioned steps is introduced. Step 400 and step 402 are substantially equal to step 200 and step 202. As the database 18 includes the actuating values B, which is inspected by the controller 20, the controller 20 can read the actuating value B according to initial setting, and can simultaneously trigger the sensor 16 to sense the corresponding environmental parameter A, so as to decide whether the mode of the memory module 12 of the electronic device 10 is switched according to the comparison of the environmental parameter A and the actuating value B. For example, as shown in FIG. 2, the illumination sensor and the magnetic sensor are selected according to the above-mentioned steps, and the actuating values B from the database 18 are the illumination (the range between 270 candlepower and 330 candlepower) and the magnetic field (the direction of the east that has the tolerance of ten percent inclination). At this time, the controller 20 triggers the illumination sensor and the magnetic sensor to immediately sense the environmental parameters A of the position whereon the electronic device 10 is located, and compares the environmental parameters A to the actuating values B.

When at least one environmental parameter A does not correspond to the actuating value B, the auto-switch program is disabled by the controller 20 because the electronic device 10 is not put under the predetermined condition, so the modes of the memory module 12 can not be switched automatically. Further, when the plurality of environmental parameters A corresponds to the plurality of actuating values B, and the electronic device 10 is electrically connected to the external host 22 via the connector 14, the memory module 12 can be coupled to be the external memory module of the external host 22 by the controller 20. Therefore, the present invention can automatically switch the modes of the memory module according to its environmental parameters, and can effectively economize operation period instead of conventional manual inputting operation.

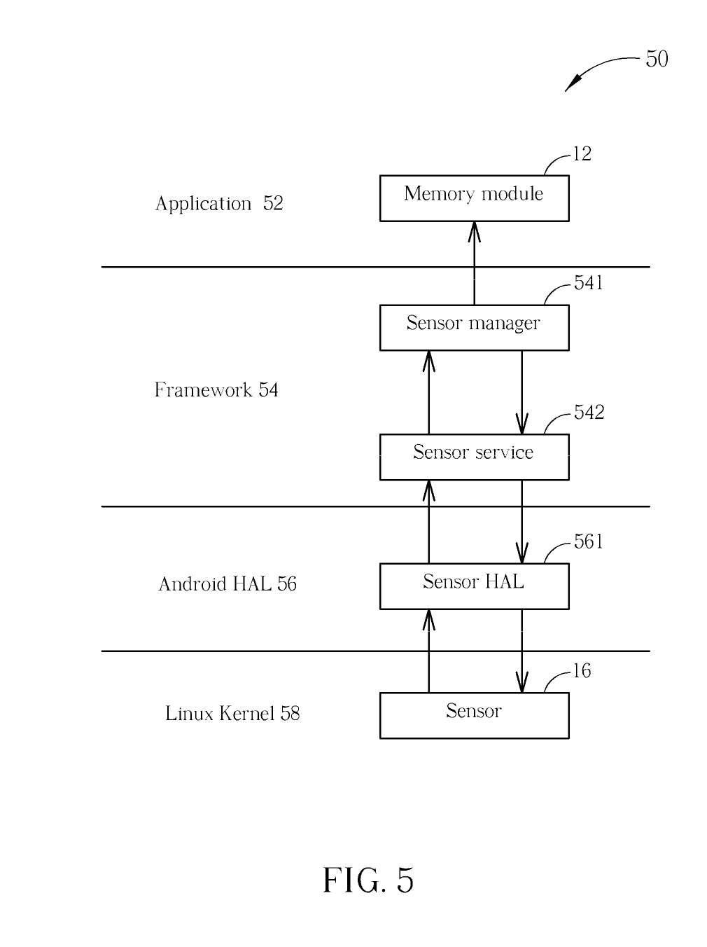

Please refer to FIG. 5. FIG. 5 is a diagram illustrating the electronic device 10 with software 50 according to the embodiment of the present invention. As shown in FIG. 5, the software 50 can include application 52 in the first layer, framework 54 in the second layer, Android HAL 56 in the third layer, and Linux Kernel 58 in the fourth layer. The application 52 is performed by the memory module 12. The framework 54 is performed by sensor manager 541 and sensor service 542. Function of the sensor 16 in the Android HAL 56 is performed by sensor HAL 561.

When the controller 20 gets a result that the environmental parameter A corresponds to the actuating value B, the sensor manager 541 can output an actuating command to the sensor service 542 for reading/sensing the environmental parameter A, and then the sensor service 542 can output a request to the sensor HAL 561 for driving the sensor 16 to sense the environmental parameter A. When the sensor HAL 561 receives mode of the sensor 16 from the Linux Kernel 58, the sensor manager 541 and the sensor service 542 can obtain the latest environmental parameter A in sequence, so that the sensor manager 541 can compare the environmental parameter A to the actuating value B for determining whether the memory module 12 is coupled to be the external memory module of the external host 22 via the connector 14.

In conclusion, the present invention utilizes the sensors to sense the environmental parameters of the position whereon the electronic device is located, and compares the environmental parameters to the actuating values stored inside the built-in database, so as to determine whether the modes of the memory module can be switched. Because the electronic device (the common smart phone) includes many kinds of sensors, such as the illumination sensor, the distance sensor, the linear acceleration sensor, the gyroscope sensor or the magnetic sensor, the controller can read the environmental parameters sensed by the different kinds of sensors, and then utilize the comparison of the environmental parameters and the predetermined actuating values to be the reference for switching the modes of the memory module. Comparing to the prior art, the present invention has preferred convenience instead of the conventional manual inputting operation. The electronic device of the present invention can utilize the controller to execute the comparison and to switch the mode of the memory module automatically when the electronic device is put under the predetermined condition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of automatically switching modes of a memory module of an electronic device, the method comprising:
enabling an auto-switch program;
reading an actuating value in database;
triggering a sensor;
comparing the actuating value and an environmental parameter sensed by the sensor; and
switching the mode of the memory module when the environmental parameter corresponds to the actuating value.

2. The method of claim 1, further comprising:
reading a plurality of actuating values in the database;
triggering a plurality of sensors;
comparing the plurality of actuating values and the environmental parameters sensed by the corresponding sensors; and
switching the mode of the memory module when the environmental parameters correspond to the actuating values.

3. The method of claim 1, wherein reading the actuating value in the database comprises:
starting a setting program when the database does not store the actuating value;
listing a plurality of sensors;
selecting at least one sensor;
triggering the selected sensor to generate a sensing value; and
storing the sensing value into the database to be the actuating value.

4. The method of claim 3, wherein reading the actuating value in the database further comprises:
setting a tolerance of the sensing value; and
storing the sensing value and the tolerance into the database to be the actuating value.

5. The method of claim 4, wherein the tolerance is substantially equal to ten percent of the sensing value.

6. The method of claim 1, wherein comparing the actuating value and the environmental parameter sensed by the sensor comprises:
disabling the auto-switch program when the environmental parameter does not correspond to the actuating value.

7. The method of claim 1, wherein switching the mode of the memory module of the electronic device comprises:
coupling the memory module of the electronic device to be an external memory module of an external host when the electronic device is electrically connected to the external host.

8. The method of claim 1, wherein the sensor is an illumination sensor, a distance sensor, a linear acceleration sensor, a gyroscope sensor or a magnetic sensor.

9. An electronic device capable of auto-switching memory module modes, the electronic device comprising:
a memory module;
a connector disposed on the memory module, the memory module being electrically connected to an external host via the connector;
at least one sensor, the sensor being triggered to sense an environmental parameter;
a database for storing an actuating value; and
a controller electrically connected to the memory module, sensor and the database, the controller being for reading the actuating value from the database after an auto-switch program is enabled, comparing the actuating value and the environmental parameter, and switching a mode of the memory module when the environmental parameter corresponds to the actuating value.

10. The electronic device of claim 9, wherein the electronic device further comprises a plurality of sensors, each sensor senses a corresponding environmental parameter, the controller further reads a plurality of actuating values from the database, and compares the environmental parameters to the corresponding actuating values, so as to switch the mode of the memory module when the environmental parameters respectively correspond to the actuating values.

11. The electronic device of claim 9, wherein the electronic device further comprises a display interface electrically connected to the controller, the controller drives the display interface to list a plurality of sensors when the controller does not read the actuating value from the database, and triggers at least one selected sensor to generate a sensing value, so as to store the sensing value into the database to be the actuating value.

12. The electronic device of claim 11, wherein the controller further sets a tolerance of the sensing value, and stores the sensing value and the tolerance into the database to be the actuating value.

13. The electronic device of claim 12, wherein the tolerance is substantially equal to ten percent of the sensing value.

14. The electronic device of claim 9, wherein the auto-switch program is disabled by the controller when the environmental parameter does not correspond to the actuating value.

15. The electronic device of claim 9, wherein the memory module is coupled to be an external memory module of the external host when the controller switches the mode of the memory module.

16. The electronic device of claim 9, wherein the sensor is an illumination sensor, a distance sensor, a linear acceleration sensor, a gyroscope sensor or a magnetic sensor.
